(19) United States
(12) Patent Application Publication
(10) Pub. No.: US 2007/0183827 A1
(43) Pub. Date: Aug. 9, 2007

(54) IMAGE FORMING DEVICE

(75) Inventor: Hiroshi TERASHITA, Kyoto (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/560,918

(22) Filed: Nov. 17, 2006

(30) Foreign Application Priority Data
Feb. 6, 2006 (JP) 2006-028619
Feb. 6, 2006 (JP) 2006-028620
Feb. 6, 2006 (JP) 2006-028621
Oct. 16, 2006 (JP) 2006-281500
Oct. 16, 2006 (JP) 2006-281501
Oct. 16, 2006 (JP) 2006-281502

(51) Int. Cl. G03G 15/00

(52) U.S. Cl. 399/391; 399/393

(57) ABSTRACT

In an image forming device, at least one optional paper cassette can be vertically mounted below a device main body having an image forming portion. A pickup roller picks up a recording paper from a recording paper storage portion adjacent a recording paper transportation path in the optional paper cassette. A feed roller transports the recording paper through the recording paper transportation path in the optional paper cassette from upstream to downstream. A combination of a power source and a power transmission path, which are used to drive both the pickup roller and the feed roller, can be optionally changed, and consequently, a plurality of operation arrangements can be utilized.

### BACKGROUND OF THE INVENTION

1. Field of the Invention

The present invention relates to an image forming device used in a copy machine, a facsimile, and a printer. In particular, the image forming device of the present invention includes at least one optional paper cassette that is used for feeding paper and is vertically mounted below a device main body. A recording paper is transported from the optional paper cassette to an image forming portion through a recording paper transportation path in the optional paper cassette and a recording paper transportation path in the device main body.

2. Description of the Related Art

In a conventional image forming device, optional paper cassettes are sequentially added from top to bottom below a device main body. Thus, a large number of papers can be stacked. Also, various sized recording papers and various types of recording papers can be stacked and selectively used.

Power to feed and transport the recording paper from the optional paper cassette is transmitted from a motor mounted in the device main body to the optional paper cassette. However, the conventional image forming device has only one power transmission path. Accordingly, if a failure occurs in the motor or a component of the power transmission path, a paper feeding mechanism and a paper transporting mechanism of the optional paper cassette may stop operating partially or entirely. Also, in the case in which the device main body is mounted with a plurality of optional paper cassettes, a single motor causes a lack of torque in some specifications. As a result, the paper feeding mechanism and the paper transporting mechanism of all of the optional paper cassettes may stop operating. In order to overcome the above-described problems, extra motors are added just to drive the paper feeding mechanism and the paper transporting mechanism of the optional paper cassettes. In such a case, however, an optional paper cassette with another power transmission path is needed to be replaced, resulting in an increase in device cost.

In the conventional image forming device, a single motor in the device main body drives all of the paper feeding and paper transporting mechanisms. Therefore, each time an optional paper cassette is added, a load on the motor increases. Accordingly, assuming that a plurality of optional paper cassettes are added to the device main body, the device main body is pre-designed to be mounted with an expensive motor having a large power output. Otherwise, according to some specifications of the motor in the device main body, a lack of torque may occur when the motor drives the paper transport ting mechanism of the optional paper cassette. When the recording paper is fed from a main cassette or an upper optional paper cassette, the motor simultaneously drives the paper transporting mechanism of lower optional paper cassettes, which do not need to operate. As a result, power is consumed wastefully.

Conventionally, when the recording paper is fed from the optional paper cassettes located below a second optional paper cassette from the top, a feed roller, which is mounted along the recording paper transportation path in the optional paper cassette, transports the recording paper towards the device main body. In such cases, all of the motors mounted in the paper cassettes located above the fourth optional paper cassette are also required to be driven. As a result, power is consumed wastefully.

### SUMMARY OF THE INVENTION

In order to overcome the problems described above, preferred embodiments of the present invention provide an image forming device including a plurality of operation arrangements (a combination of a power source and a power transmission path) of both a paper feeding mechanism and a paper transporting mechanism of an optional paper cassette. Therefore, an appropriate operation arrangement can be selected accordingly.

According to a preferred embodiment of the present invention, the image forming device includes at least one optional paper cassette that feeds paper and is vertically mounted below a device main body having an image forming portion. A recording paper is transported from the optional paper cassette to the image forming portion through a recording paper transportation path in the optional paper cassette and a recording paper transportation path in the device main body. Each optional paper cassette has a recording paper storage portion, a pickup roller, and a feed roller. A pile of recording papers is stacked in the recording paper storage portion. The pickup roller picks up the recording paper from the recording paper storage portion adjacent the recording paper transportation path in the optional paper cassette. The feed roller transports the recording paper from upstream to downstream through the recording paper transportation path in the optional paper cassette. The combination of the power source and the power transmission path, which are used to drive the pickup roller and the feed roller, can be optionally changed. As a result, a plurality of operation arrangements can be utilized.

According to the above-described preferred embodiment of the present invention, if a failure occurs in the paper feeding mechanism and the paper transporting mechanism of the optional paper cassette, a user or a service person can change the operation arrangement. As a result, the user can avoid a state in which the optional paper cassettes become partially or entirely inoperative. In addition, upon consideration of a component cost and a load on a motor in the device main body, an appropriate operation arrangement can be selected accordingly.

According to another preferred embodiment of the present invention, the power transmission path is constructed using only gears attached to a bracket, which is mounted in each optional paper cassette. The bracket is mounted with a plurality of gear attaching portions so that a path of a gear train can be changed accordingly.

According to such a preferred embodiment of the present invention, the power transmission path in the optional paper cassette can be optionally changed. In addition, since the power transmission path is constructed using only gears, power loss can be reduced.

According to another preferred embodiment of the present invention, in the image forming device of the present invention, the power source is either a main motor mounted in the device main body or a sub motor mounted in each optional paper cassette.

According to such a preferred embodiment of the present invention, if a failure occurs in the paper feeding mechanism and the paper transporting mechanism of the optional paper cassette, the operation arrangement of the pickup roller and the feed roller can be changed. As a result, the user can avoid a state in which the optional paper cassettes become inoperative. In addition, upon consideration of a component cost and a load on the motor in the device main body, an appropriate operation arrangement can be selected accordingly.

In order to overcome the above-described problems, and according to preferred embodiments of the present invention, a load on a motor in a device main body can be reduced when an optional paper cassette is used. In addition, power is not consumed wastefully.

According to a preferred embodiment of the present invention, an image forming device includes at least one optional paper cassette used for feeding paper and is vertically mounted below the device main body having an image forming portion. A recording paper is transported from the optional paper cassette to the image forming portion through recording paper transportation paths in both the optional paper cassette and the device main body. Each optional paper cassette has a recording paper storage portion, a pickup roller, a feed roller, and a motor. A pile of recording papers is stacked in the recording paper storage portion. The pickup roller picks up the recording paper from the recording paper storage portion adjacent the recording paper transportation path in the optional paper cassette. The feed roller transports the recording paper from upstream to downstream through the recording paper transportation path in the optional paper cassette. The pickup roller is rotated by power transmitted from the motor mounted in the same optional paper cassette as the pickup roller. The feed roller is rotated by power transmitted from the motor mounted in an optional paper cassette located below the optional paper cassette where the rotated feed roller is provided.

According to the above-described preferred embodiment of the present invention, the image forming device is not required to include an expensive motor having a large power output in the device main body. Therefore, a manufacturing cost of the image forming device can be reduced. In addition, the optional paper cassettes can be added without considering the load on the motor in the device main body.

According to another preferred embodiment of the present invention, each optional paper cassette has an output transmission mechanism and an input transmission mechanism. The output transmission mechanism is connected to the motor in the optional paper cassette. The input transmission mechanism is connected to the feed roller in the optional paper cassette. When the optional paper cassettes are vertically mounted below the device main body, the output transmission mechanism of a lower optional paper cassette is connected to the input transmission mechanism of an upper optional paper cassette.

According to such a preferred embodiment of the present invention, the image forming device is not required to include an expensive motor having a large power output in the device main body. Therefore, the manufacturing cost of the image forming device can be reduced. In addition, the optional paper cassettes can be added without considering the load on the motor in the device main body.

According to another preferred embodiment of the present invention, both the input transmission mechanism and the output transmission mechanism are constructed using only gears.

According to the above-described preferred embodiment of the present invention, a power transmission path in the optional paper cassette can be optionally constructed. In addition, by constructing the power transmission path using only gears, a power loss in the power transmission path can be reduced.

In order to overcome the above-described problems, a motor in an optional paper cassette of a preferred embodiment of the present invention does not consume power wastefully.

According to a preferred embodiment of the present invention, an image forming device includes at least one optional paper cassette that feeds paper and is vertically mounted below a device main body having an image forming portion. A recording paper is transported from the optional paper cassette to the image forming portion through recording paper transportation paths in both the optional paper cassette and the device main body. Each optional paper cassette has a recording paper storage portion, a pickup roller, a feed roller, and the motor. A pile of recording papers is stacked in the recording paper storage portion. The pickup roller picks up the recording paper from the recording paper storage portion adjacent the recording paper transportation path in the optional paper cassette. The feed roller transports the recording paper from upstream to downstream through the recording paper transportation path in the optional paper cassette. The pickup roller receives the power transmitted from the motor mounted in the same optional paper cassette as the pickup roller. The feed roller receives the power transmitted from a motor mounted in the device main body.

According to the above-described preferred embodiment of the present invention, the recording paper can be picked up and transported only by driving the motor mounted in the device main body and the motor mounted in the optional paper cassette selected for paper feeding. In other words, there is no need to drive other motors mounted in unselected optional paper cassettes. As a result, power is not consumed wastefully, and noise can be reduced.

According to another preferred embodiment of the present invention, the power transmission path to both the feed roller and the pickup roller can be constructed using only gears.

According to such a preferred embodiment of the present invention, power loss in the power transmission path is very small. In addition, the power transmission path can be optionally changed.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross section view from a backside of an image forming device according to a preferred embodiment of the present invention.

FIGS. 2A and 2B illustrate a bracket mounted in an optional paper cassette. FIG. 2A illustrates a bracket having no gears attached and FIG. 2B illustrates a bracket having all of the gears attached.

FIG. 3 illustrates a first operation arrangement.

FIG. 4 illustrates a second operation arrangement.

FIG. 5 illustrates a third operation arrangement.

### DETAILED DESCRIPTION OF PREFERRED EMBODIMENTS

A description will be made of an image forming device according to preferred embodiments of the present invention. In the preferred embodiments of the present invention, a printer using an electrophotographic system is described as an example of the image forming device.

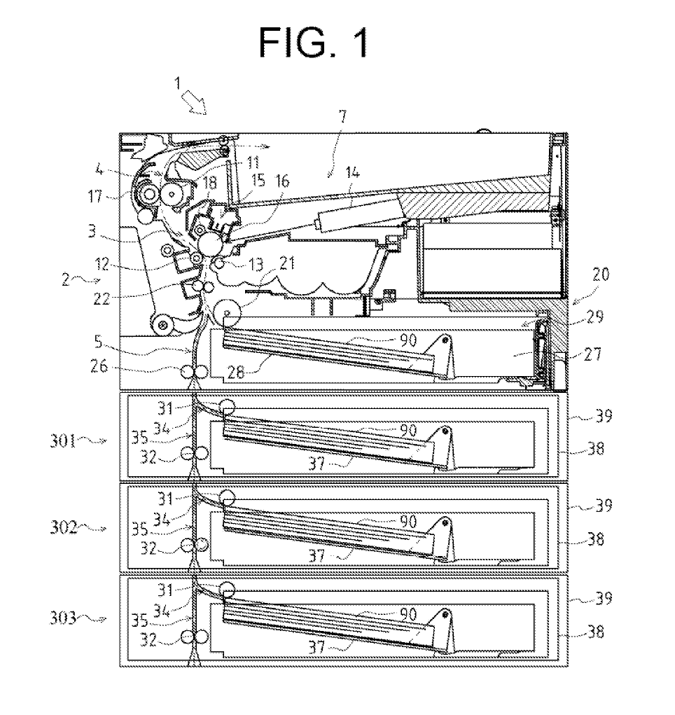

As illustrated in FIG. 1, an image forming device 1 includes a device main body 2. The device main body 2 includes an image forming portion 3 and a main cassette 20. Recording papers are stacked in the main cassette 20. At least one optional paper cassette can be vertically mounted below the device main body 2. The recording papers are also stacked in the at least one optional paper cassette. The recording paper is transported to a copy receiving tray 7 through a recording paper transportation path 35 in each optional paper cassette and recording paper transportation paths 5 and 4 in the device main body 2.

The main cassette 20 is mounted at a bottom of the device main body 2. The main cassette 20 includes a recording paper storage portion 27. The recording papers are stacked in the recording paper storage portion 27. The recording paper storage portion 27 is horizontally inserted from a front side of the device main body 2 into an attachment portion 29 mounted in the device main body 2.

The recording paper transportation path 4 is provided in the device main body 2. The recording paper transportation path 4 leads from the main cassette 20 through the image forming portion 3 to the copy receiving tray 7. The copy receiving tray 7 is mounted on an upper portion of the device main body 2. Along the recording paper transportation path 4, a pickup roller 21, resist rollers 22, the image forming portion 3, and a fixing device are sequentially arranged in a paper transportation direction. The fixing device includes a heat roller 11 and a press roller 17. A controller mounted in the device main body 2 controls the above-described devices, which are driven by power transmitted from a main motor (not illustrated in FIG. 1) provided in the device main body 2.

A bottom plate 28 is provided at a bottom of the recording paper storage portion 27 in the main cassette 20. A pile of recording papers 90 can be stacked on the bottom plate 28. When the recording paper storage portion 27 is inserted into the attachment portion 29, a paper feeding side of the bottom plate 28 elevates by being urged upward by an urging spring (not illustrated in FIG. 1). As a result, an edge of an uppermost recording paper of the pile of recording papers 90 is pressed against the pickup roller 21.

A clutch is attached to a shaft of the pickup roller 21. The clutch transmits or cuts off the power transmitted from the main motor to the shaft. When the clutch is connected in response to a request for paper feeding from the controller, one sheet of recording paper is picked up from the pile of recording papers 90. The picked-up recording paper is transported towards the image forming portion 3.

A toner image is transferred onto the recording paper at the image forming portion 3. In the following, a description will be made of a transferring process of the toner image. A surface of a photoconductive drum 16 is charged by a charger 15. A laser scanning device 14 exposes the surface of the charged photoconductive drum 16. As a result, an electrostatic latent image is formed on the photoconductive drum 16. The toner is attracted to the electrostatic latent image from a developing roller 13. Accordingly, the toner image is retained on the surface of the photoconductive drum 16. The toner image is transferred onto the recording paper by a transfer roller 12. A residual toner remaining on the surface of the photoconductive drum 16 is scraped off by a roller 18. The recording paper with the transferred toner image passes through the fixing device, whereby the toner image is fixed onto the recording paper. The recording paper is then output onto the copy receiving tray 7.

Next, a description will be made of the optional paper cassette, and a paper feeding mechanism and a paper transporting mechanism of the optional paper cassette. As illustrated in FIG. 1, according to preferred embodiments of the present invention, three optional paper cassettes 301, 302, and 303 are vertically mounted below the device main body 2. Accordingly, the image forming device 1 has four paper cassettes including the main cassette 20 in the device main body 2. The main cassette 20, a top optional paper cassette 301, a next optional paper cassette 302, and a bottom optional paper cassette 303 hereafter will be respectively referred to as a first paper cassette 20, a second paper cassette 301, a third paper cassette 302, and a fourth paper cassette 303.

The optional paper cassette includes a box-shaped housing 39 and a storage portion 38. The storage portion 38 is pulled in and out at a front side of the housing 39, and accommodates the pile of recording papers 90. A vertically extending transportation path 35 is also mounted in the optional paper cassette.

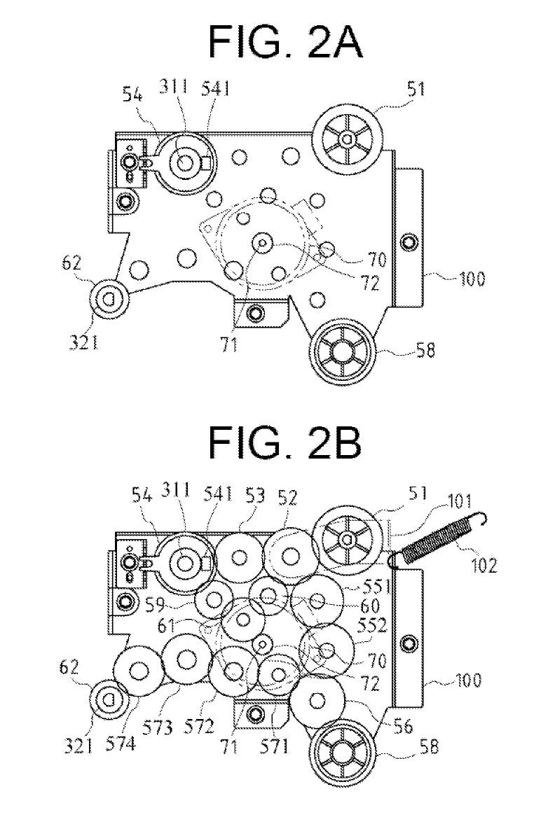

Each optional paper cassette includes a pickup roller 31 and a feed roller 32, and also includes a sub motor 70 (see FIG. 2) if needed. The pickup roller 31 picks up one sheet of recording paper at a time from the storage portion 38, and transports the recording paper towards the transportation path 35. The feed roller 32 transports the recording paper from upstream to downstream through the transportation path 35. A transportation path 34 connects the storage portion 38 and the transportation path 35. The recording paper picked up by the pickup roller 31 passes through the transportation paths 34 and 35. The feed roller 32 in the transportation path 35 is arranged upstream of a junction of the feed roller 32 and the transportation path 34. The feed roller 32 transports the recording paper, which has been transported from the optional paper cassette located directly below, further downstream.

A transportation path 5 is provided in the device main body 2. The transportation path 5 connects the transportation path 35 in the second paper cassette 301 to the transportation path 4 in the device main body 2 in order to transport the recording paper. A feed roller 26 is mounted at a lower position of the transportation path 5. The feed roller 26 feeds the recording paper transported from the second paper cassette 301 to the transportation path 5. The feed roller 26 is rotated by the power transmitted from the main motor in the device main body 2. In the following, a description will be made of an example in which the recording paper is fed from the fourth paper cassette 303. The recording paper picked up by the pickup roller 31 in the fourth paper cassette 303 is transported downstream by the feed roller 32 in the third paper cassette 302 and the feed roller 32 in the second paper cassette 301. The recording paper then enters the transportation path 5 in the device main body 2, and is transported by the feed roller 26 to the transportation path 4.

Next, a description will be made of an operation arrangement of the rollers 31 and 32 provided in the paper cassette. In this specification, the operation arrangement is defined as a combination of a power source and a power transmission path, which are used to drive both the pickup roller 31 and the feed roller 32 in each optional paper cassette. According to preferred embodiments of the present invention, three operation arrangements can be utilized. The main motor in the device main body 2 or the sub motor 70 in each optional paper cassette is optionally selected as the power source. According to a first operation arrangement, the main motor in the device main body 2 rotates the rollers 31 and 32 in all of the optional paper cassettes. According to a second operation arrangement, the power is not transmitted from the main motor to the rollers 31 and 32. In other words, the sub motor 70 in each optional paper cassette rotates both the pickup roller 31 and the feed roller 32 mounted in the same optional paper cassette as the sub motor. According to a third operation arrangement, the pickup roller 31 is rotated by the power transmitted from the sub motor 70 mounted in the same optional paper cassette as the pickup roller. The feed roller 32 is rotated by the power transmitted from the main motor in the device main body 2.

In the image forming device 1 according to preferred embodiments of the present invention, the operation arrangements in the optional paper cassette can be changed just by replacing gears on a bracket 100. Only gears can be attached to the bracket 100. Therefore, when the gears are attached to the bracket 100 according to the first operation arrangement, if a failure occurs in a portion of the gears, the optional paper cassette can be used again by replacing the gears according to the second operation arrangement, which does not use the main motor. When the gears are attached to the bracket 100 according to the second or third operation arrangement, if a failure occurs in the sub motor 70, the optional paper cassette can be used again by replacing the gears according to the first operation arrangement in which power is transmitted only from the main motor. If another optional paper cassette is added when the gears are attached according to the first operation arrangement, an excess load is placed on the main motor in the device main body 2, resulting in a lack of torque. In such a case, if a user or a service person replaces the gears according to the second operation arrangement, the optional paper cassette can be added without increasing the load on the main motor. According to the second operation arrangement, as more optional paper cassettes are added, both noise from the sub motor 70 and power consumption increase. In such a case, if the user or the service person replaces the gears according to the third operation arrangement, the main motor and only one sub motor 70 are used simultaneously. Thus, the noise from the image forming device 1 can be reduced as a whole. As a result, power consumption in the image forming device 1 can be reduced.

As illustrated in FIG. 2A, the bracket 100 is provided on a backside of the optional paper cassette. A gear 54, which is used to drive the pickup roller 31, and a gear 62, which is used to drive the feed roller 32, are attached to the bracket 100. The gear 54 is fixed at an edge of a rotation shaft 311 of the pickup roller 31 (see FIG. 1). The gear 62 is fixed at an edge of a rotation shaft 321 of the feed roller 32 (see FIG. 1).

A plurality of studs (gear attaching shafts) are attached to the bracket 100. An idle gear, which is driven to transmit the power to the gears 54 and 62, can be attached to each stud. According to preferred embodiments of the present invention, in the image forming device 1, a combination of the gears attached to the bracket 100 can be changed. Therefore, three operation arrangements (arrangements of gear trains) can be utilized. FIG. 2B illustrates the gears attached to all of the studs. Only the necessary gears according to the required operation arrangement are attached to the bracket 100, and thus the operation arrangement is utilized. Preferably, two or more gear trains according to two or more operation arrangements are not utilized at the same time. In other words, each gear diameter is defined so that some of the gears interact with the gears arranged according to another gear train.

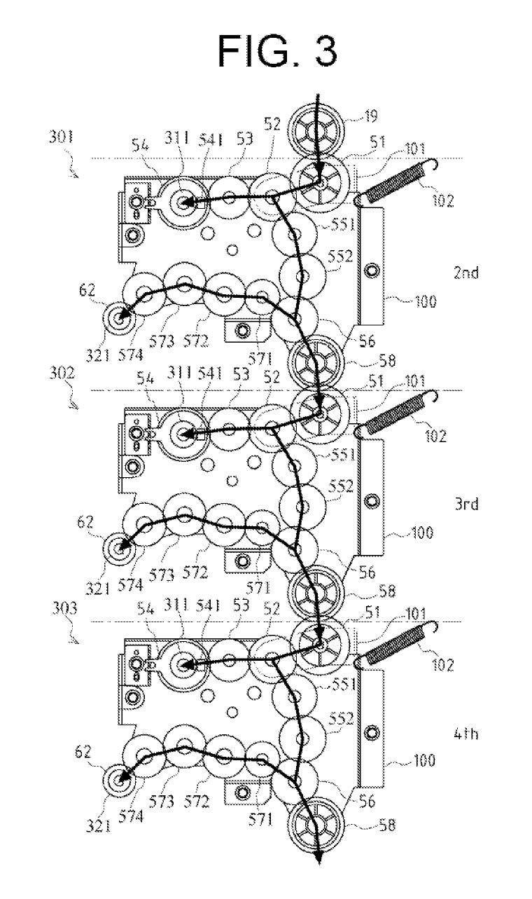

FIG. 3 illustrates the first operation arrangement. Solid-line arrows in FIG. 3 illustrate the power transmission path according to the first operation arrangement. According to the first operation arrangement, the main motor in the device main body 2 rotates the pickup rollers 31 and the feed rollers 32 in all of the optional paper cassettes. A power transmission mechanism driven by the main motor is provided in the device main body 2 in order to transmit the power from the main motor to the optional paper cassettes. An output gear 19 is attached to an end edge of the power transmission mechanism.

A first linking gear 51 is attached to an upper edge of each bracket 100. A second linking gear 58 is attached to a lower edge of each bracket 100. When two optional paper cassettes are vertically mounted, the second linking gear 58 in the upper optional paper cassette engages with the first linking gear 51 in the lower optional paper cassette. The first linking gear 51 in the second paper cassette 301 engages with the output gear 19 in the device main body 2.

The first linking gear 51 is supported by an arm 101. The arm 101 can be swung around a shaft of an idle gear 52. The arm 101 and the housing 39 are connected by a spring 102. The spring 102 urges the first linking gear 51 towards the second linking gear 58 in the upper optional paper cassette or the output gear 19 in the device main body. Therefore, the first linking gear 51 reliably engages with the second linking gear 58, and the first linking gear 51 reliably engages with the output gear 19. As a result, power from the main motor can be appropriately transmitted to the optional paper cassette.

The gear 54 is driven to transmit the power to the pickup roller 31. The gear 54 is connected via an idle gear 53 and the idle gear 52 to the first linking gear 51 mounted in the same optional paper cassette as the gear 54 so that the power can be transmitted thereto. The gear 62 is driven to transmit the power to the feed roller 32. The gear 62 is connected via idle gears 574, 573, 572, 571, 56, 552, 551, and 52 to the first linking gear 51 mounted in the same optional paper cassette as the gear 62 so that the power can be transmitted thereto. The first linking gear 51 is connected via the idle gears 52, 551, 552, and 56 to the second linking gear 58 mounted in the same optional paper cassette as the first linking gear 51 so that the power can be transmitted thereto. Accordingly, when the optional paper cassettes are vertically mounted below the device main body 2, the power is transmitted from the main motor in the device main body 2 to all of the pickup rollers 31 and the feed rollers 32 mounted in all of the optional paper cassettes, and consequently, all of the rollers 31 and 32 are rotated.

According to the first operation arrangement, since the sub motor 70 is not driven, the sub motor 70 is not required to be attached to the bracket 100. Since idle gears 59, 60, and 61 (see FIG. 2B), which are used to transmit the power from the sub motor 70, are not driven, the idle gears 59, 60, and 61 are not required to be attached to the bracket 100.

With reference to FIGS. 1 and 3, a description will be made of an example of an operation for transporting the recording paper from the fourth paper cassette 303 according to the first operation arrangement. A bottom plate 37 is mounted at a bottom of the storage portion 38 in the fourth paper cassette 303. A pile of recording papers 90 is stacked on the bottom plate 37. A paper feeding side of the bottom plate 37 is elevated by being urged upward by an urging spring (not illustrated in FIGS. 1 and 3). As a result, an edge of an uppermost recording paper of the pile of recording papers 90 is pressed against the pickup roller 31.

A clutch 541 is attached to the gear 54. In response to a connection instruction from the controller, only the clutch 541 in the fourth paper cassette 303 selected for paper feeding is connected, while other clutches 541 in the unselected paper cassettes 301 and 302, and the clutch in the main cassette 20 are not connected. Accordingly, only the rotation shaft 311 in the fourth paper cassette 303 is connected to the gear 54 and rotated. As a result, the recording paper is transported by the pickup roller 31 from the storage portion 38 into the transportation path 34.

The recording paper is transported from the transportation path 34 downstream through the transportation paths 35 in both the third and second paper cassettes 302 and 301 by the feed rollers 32 in both the third and second paper cassettes 302 and 301. The recording paper then enters the transportation path 5 in the device main body 2 from the transportation path 35 in the second paper cassette 301. The recording paper is then transported further downstream through the transportation path 5 by the feed roller 26 in the device main body 2, and transported into the image forming portion 3 through the transportation path 4.

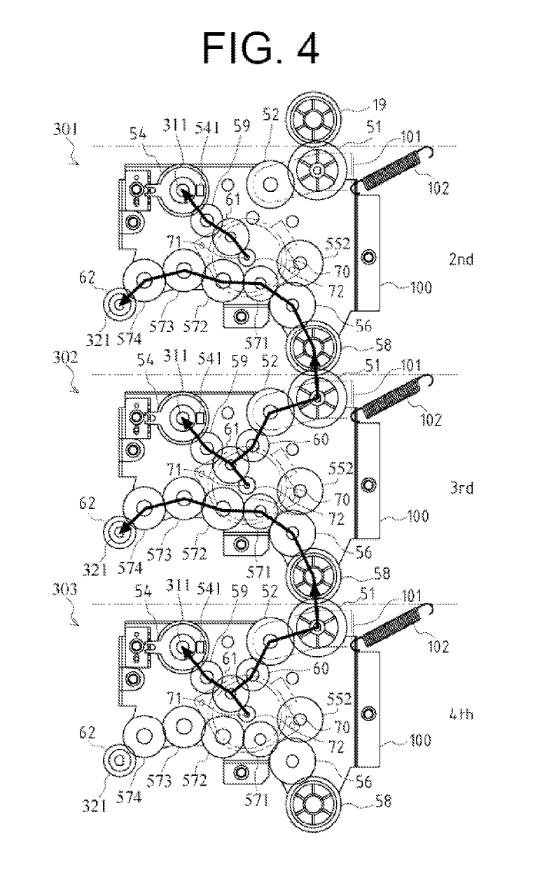

FIG. 4 illustrates the second operation arrangement. Solid-line arrows in FIG. 4 illustrate the power transmission path according to the second operation arrangement. According to the second operation arrangement, the sub motor 70 is mounted in each optional paper cassette. The power from the sub motor 70 is transmitted to the pickup roller 31 mounted in the same optional paper cassette as the sub motor 70. The power from the sub motor 70 is also transmitted to the feed roller 32 mounted in the optional paper cassette located directly above. Therefore, the power from the main motor in the device main body 2 is not transmitted to the pickup roller 31 and the feed roller 32 in the optional paper cassette.

The sub motor 70 is fixed on a surface of the bracket 100 on an opposite side of a gear attaching side. An output shaft 71 of the sub motor 70 penetrates in a thickness direction through the bracket 100 and protrudes on the gear attaching side. An output gear 72 is fixed on an edge of the output shaft 71.

The gear 54 in each optional paper cassette is connected via the idle gears 59 and 61 to the output gear 72. As a result, the power from the sub motor 70 in each optional paper cassette is transmitted only to the pickup roller 31 mounted in the same optional paper cassette as the sub motor. In other words, for example, the power from the sub motor 70 in the third paper cassette 302 is transmitted only to the pickup roller 31 in the third paper cassette 302.

When two optional paper cassettes are vertically mounted, the gear 62 in the upper optional paper cassette is connected to the gear 72 fixed on the output shaft of the sub motor 70 in the lower optional paper cassette via the gears 574, 573, 572, 571, 56, and 58 in the upper optional paper cassette, and the gears 51, 52, 60, and 61 in the lower optional paper cassette. Therefore, the feed roller 32 in the upper optional paper cassette only receives the power transmitted from the sub motor 70 in the lower optional paper cassette.

According to the second operation arrangement, the gears 72, 61, 60, 52, and 51 define an output transmission mechanism, which outputs the power from the sub motor 70 to the upper optional paper cassette. The gears 58, 56, 571, 572, 573, 574, and 62 define an input transmission mechanism, which inputs the power from the lower optional paper cassette to the feed roller 32. By connecting the output transmission mechanism of the lower optional paper cassette to the input transmission mechanism in the upper optional paper cassette, the power from the sub motor 70 in the lower optional paper cassette is transmitted to the feed roller 32 in the upper optional paper cassette and rotates the feed roller 32. According to the second operation arrangement, the gear 551 (see FIG. 2B) is not used. Therefore, the output transmission mechanism and the input transmission mechanism in one optional paper cassette do not transmit the power to each other. Further, by preventing the gear 552 from being used, or by preventing both the gears 551 and 552 from being used, the power may be prevented from being transmitted between the output transmission mechanism and the input transmission mechanism. According to the second operation arrangement, the gear 53 (see FIG. 2B) is not used.

According to the second operation arrangement, it is not necessary to transmit the power between the device main body 2 and the second paper cassette 301. Therefore, the idle gear 60 is not mounted in the second paper cassette 301. Thus, the power from the sub motor 70 in the second paper cassette 301 is not transmitted to the device main body 2.

With reference to FIGS. 1 and 4, a description will be made of an example of an operation for transporting the recording paper from the fourth paper cassette 303 according to the second operation arrangement. In response to an instruction for paper feeding from the controller in the device main body 2, the sub motors 70 in the third and fourth paper cassettes 302 and 303, and not the second paper cassette 301, are driven. When a paper feeding clutch 541 in the fourth paper cassette 303 is connected, the recording paper is transported through the transportation path 34 to the transportation path 35. The recording paper is then transported towards the device main body 2 by the feed rollers 32 in both the third and second paper cassettes 302 and 301. The feed roller 32 in the third paper cassette 302 is rotated by the power transmitted from the sub motor 70 in the fourth paper cassette 303. The feed roller 32 in the second paper cassette 301 is rotated by the power transmitted from the sub motor 70 in the third paper cassette 302.

In the above-described example in which the recording paper is fed from the third or fourth paper cassettes 302 or 303, the sub motor 70 in the second paper cassette 301 is not required to be driven. Therefore, according to the second operation arrangement, only the sub motors 70 in the third paper cassette 302 and the fourth paper cassette 303 selected for paper feeding are required to be driven. When the recording paper is fed from the second paper cassette 301 located directly below the device main body 2, only the pickup roller 31 in the second paper cassette 301 is required to be rotated. Therefore, since the feed rollers 32 in the second, third, and fourth paper cassettes 301, 302, and 303 are not required to be rotated, only the sub motor 70 in the second paper cassette 301 is driven.

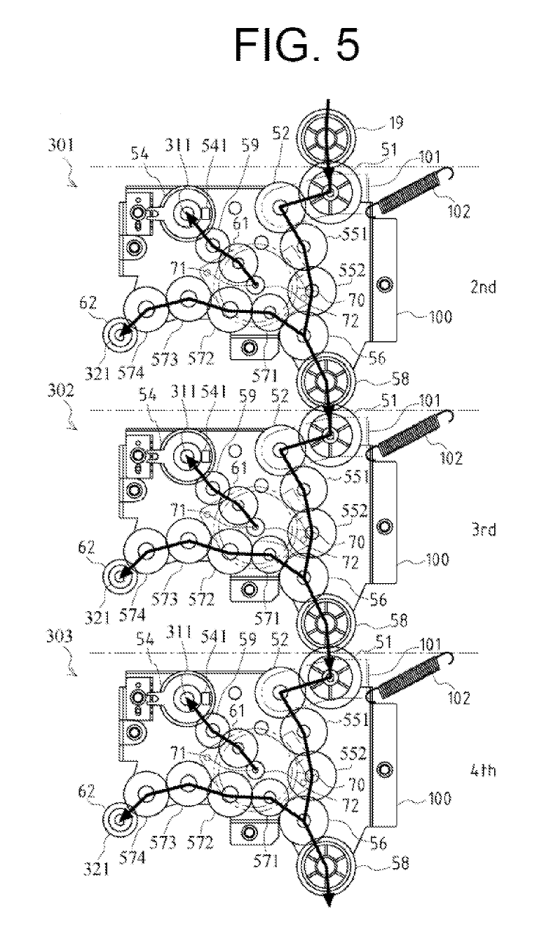

FIG. 5 illustrates the third operation arrangement. Solid-line arrows in FIG. 5 illustrate the power transmission path according to the third operation arrangement. According to the third operation arrangement, the power is transmitted from the sub motor 70 in each optional paper cassette to the pickup roller 31 mounted in the same optional paper cassette as the sub motor. Meanwhile, the power is transmitted to all of the feed rollers 32 from the main motor in the device main body 2.

In the same manner as the second operation arrangement, the gear 54 in each optional paper cassette is connected via the gears 59, 61, and 72 to the sub motor 70 mounted in the same optional paper cassette as the gear 54. For example, the power is transmitted from the sub motor 70 in the third paper cassette 302 to the pickup roller 31 in the third paper cassette 302.

In the same manner as the first operation arrangement, the gear 62 is connected to the gear 51 via the gears 574, 573, 572, 571, 56, 552, 551, and 52. The gear 51 is connected to the gear 58 via the gears 52, 551, 552, and 56. Accordingly, when the optional paper cassettes are vertically mounted below the device main body 2, the feed roller 32 mounted in each optional paper cassette receives the power from the main motor in the device main body 2.

In other words, according to the third operation arrangement, the feed rollers 32 mounted in all of the optional paper cassettes receive power from the main motor mounted in the device main body 2. The sub motor 70 is driven to operate only the pickup roller 31 in the optional paper cassette which is selected by the controller for paper feeding. Additionally, according to the third operation arrangement, the gears 53 and 60 are not attached to the bracket 100.

A description has been made of the image forming device according to preferred embodiments of the present invention. However, the operation arrangements of each optional paper cassette are not limited to the above-described preferred embodiments. The most appropriate operation arrangement (gear train) can be utilized according to a size of the optional paper cassette and a layout of the pickup roller 31 and the feed roller 32, etc.

As for the paper feeding mechanism and the paper transporting mechanism of the optional paper cassette, two or more power transmission paths may be formed from one power source to either the pickup roller 31 or the feed roller 31. For example, the studs may be arranged to enable a plurality of the gear train paths from the sub motor 70 to be formed on the bracket 100.

In the above-described preferred embodiments, the power transmission mechanism in both the paper feeding mechanism and the paper transporting mechanism of the optional paper cassette is a gear train. However, other power transmission mechanism, such as a belt transmission mechanism, can be used partially or entirely.

The image forming device 1 according to the preferred embodiments of the present invention can be used not only in a printer but also in a copy machine, a facsimile, and a multi function peripheral having both a copy function and a facsimile function. The image forming portion 3 can use not only an electrophotographic system but also other kinds of systems, such as an inkjet system.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device comprising:
a device main body including an image forming portion and a recording paper transportation path; and
at least one optional paper cassette vertically mounted below the device main body; wherein
the at least one optional paper cassette includes a recording paper transportation path, a recording paper storage portion, a pickup roller, and a feed roller;
the recording paper storage portion accommodates a pile of recording papers, the pickup roller picks up the recording paper from the recording paper storage portion adjacent the recording paper transportation path in the at least one optional paper cassette, and the feed roller transports the recording paper through the recording paper transportation path in the at least one optional paper cassette from upstream to downstream; and
a combination of a power source and a power transmission path, which are used to drive both the pickup roller and the feed roller, is arranged to be changed.

2. The image forming device according to claim 1, wherein the at least one optional paper cassette includes a bracket having a plurality of gear attaching portions, and the power transmission path is constructed using only gears attached to the bracket in the at least one optional paper cassette.

3. The image forming device according to claim 1, wherein the power source is a main motor mounted in the device main body.

4. The image forming device according to claim 1, wherein the power source is a sub motor mounted in the at least one optional paper cassette.

5. The image forming device according to claim 1, wherein the power source is a combination of a main motor mounted in the device main body and a sub motor mounted in the at least one optional paper cassette.

6. The image forming device according to claim 1, wherein the power source is arranged to be a main motor mounted in the device main body in a first arrangement, is arranged to be a sub motor mounted in the at least one optional paper cassette in a second arrangement, and is arranged to be a combination of the main motor mounted in the device main body and the sub motor mounted in the at least one optional paper cassette in a third arrangement.

7. The image forming device according to claim 6, wherein the power transmission path is arranged to be different in each of the first, second, and third arrangements.

8. An image forming device comprising:
a device main body including an image forming portion and a recording paper transportation path; and
at least an upper and a lower optional paper cassette vertically mounted below the device main body; wherein
each optional paper cassette includes a recording paper transportation path, a recording paper storage portion, a motor, pickup roller, and a feed roller;
the recording paper storage portion accommodates a pile of recording papers, the pickup roller picks up the recording paper from the recording paper storage portion adjacent the recording paper transportation path in the optional paper cassette, and the feed roller transports the recording paper through the recording paper transportation path in the optional paper cassette from upstream to downstream; and
the pickup roller of the upper optional paper cassette is rotated by power transmitted from the motor mounted in the upper optional paper cassette, and the feed roller of the upper optional paper cassette is rotated by power transmitted from the motor mounted in the lower optional paper cassette.

9. The image forming device according to claim 8, wherein each optional paper cassette includes an output transmission mechanism and an input transmission mechanism, the output transmission mechanism is connected to the motor in the same optional paper cassette as the output transmission mechanism, the input transmission mechanism is connected to the feed roller, and when the optional paper cassettes are vertically mounted, the output transmission mechanism of the lower optional paper cassette is connected to the input transmission mechanism of the upper optional paper cassette.

10. The image forming device according to claim 9, wherein both the input transmission mechanism and the output transmission mechanism are constructed using only gears.

11. An image forming device comprising:
a device main body which includes a main motor, an image forming portion, and a recording paper transportation path; and
at least one optional paper cassette vertically mounted below the device main body; wherein
the at least one optional paper cassette includes a recording paper transportation path, a recording paper storage portion, a sub motor, a pickup roller, and a feed roller;
the recording paper storage portion accommodates a pile of recording papers, the pickup roller picks up the recording paper from the recording paper storage portion adjacent the recording paper transportation path, and the feed roller transports the recording paper through the recording paper transportation path in the optional paper cassette from upstream to downstream; and
the pickup roller is rotated by power transmitted from the sub motor mounted in a same optional paper cassette as the pickup roller, and the feed roller is rotated by power transmitted by the main motor in the device main body.

12. The image forming device according to claim 11, wherein power transmission paths to both the pickup roller and the feed roller are constructed using only gears.
